(19) United States
(12) Patent Application Publication
(10) Pub. No.: US 2016/0232782 A1
(43) Pub. Date: Aug. 11, 2016

(54) ELECTRONIC APPARATUS, CONTROL METHOD AND SYSTEM THEREOF

(71) Applicant: SAMSUNG ELECTRONICS CO., LTD., Suwon-si (KR)

(72) Inventors: Jin-hee LEE, Ansan-si (KR); Hoon CHOI, Yongin-si (KR); Bong-su KIM, Suwon-si (KR)

(73) Assignee: SAMSUNG ELECTRONICS CO., LTD., Suwon-si (KR)

(21) Appl. No.: 14/813,438

(22) Filed: Jul. 30, 2015

(30) Foreign Application Priority Data
Feb. 9, 2015 (KR) 10-2015-0019525

(51) Int. Cl. G08C 17/02; H04L 29/08

(52) U.S. Cl. CPC G08C 17/02; H04L 67/12; H04L 67/10

(57) ABSTRACT

An electronic apparatus includes a first communicator configured to perform communication with a remote control device, which is configured to remotely control the electronic apparatus, the first communicator having an activated state in a standby state of the electronic apparatus; a second communicator configured to perform communication with an Internet of things (IoT) server, the second communicator having an inactivated state in the standby state of the electronic apparatus; and a processor configured to, in response to receiving a sensing result signal, including a sensing result sensed by at least one sensing device, from the remote control device, activate the second communicator to transmit the sensing result received from the remote control device to the IoT server.

### CROSS-REFERENCE TO RELATED APPLICATION

This application claims priority from Korean Patent Application No. 10-2015-0019525, filed in the Korean Intellectual Property Office, on Feb. 9, 2015, the disclosure of which is incorporated herein by reference in its entirety.

### BACKGROUND

1. Field

Methods and apparatuses consistent with exemplary embodiments relate to an electronic apparatus, and a control method and a system thereof, and more particularly, to an electronic apparatus for providing an environment of Internet of things (IoT), and a control method and a system thereof.

2. Description of the Prior Art

Due to the development of electronic technology, various types of electronic products are developed and distributed, and electronic apparatuses provided with various communication functions are widely used in various places such as homes. The electronic products that are provided with communication functions may provide environments for Internet of Things (IoT).

The IoT refers to an environment in which information on things of everyday lives can be shared through wired and/or wireless networks. In various fields including a smart home and the like, information can be shared through networks. To provide an environment of IoT, various types of sensing devices and hubs for collecting sensing results from the sensing devices are used.

### SUMMARY

One or more exemplary embodiments provide an electronic apparatus capable of, upon receiving a sensing result from a sensing device, activating a certain communicator to provide the sensing result to a user, and transmitting the received sensing result to a server, and a control method and a system thereof.

According to an aspect of an exemplary embodiment, there is provided an electronic apparatus including: a first communicator configured to perform communication with a remote control device, which is configured to remotely control the electronic apparatus, the first communicator having an activated state in a standby state of the electronic apparatus; a second communicator configured to perform communication with an Internet of things (IoT) server, the second communicator having an inactivated state in the standby state of the electronic apparatus; and a processor configured to, in response to receiving a sensing result signal, including a sensing result sensed by at least one sensing device, from the remote control device, activate the second communicator to transmit the sensing result received from the remote control device to the IoT server.

The processor may be configured to transmit state information of the electronic apparatus to the remote control device, receive the sensing result signal further including an activation signal from the remote control device based on the state information of the electronic apparatus, and in response to the sensing result signal further including the activation signal, activate the second communicator.

The processor may be configured to, in response to receiving the sensing result signal, convert the sensing result signal into a signal that is in accordance with a communication standard of the second communicator, and transmit the converted signal to the IoT server.

The first communicator may be configured to perform the communication with the remote control device using a Bluetooth standard, and the second communicator may be configured to perform the communication with the IoT server using a WiFi standard, and the processor may be configured to, in response to receiving the sensing result signal, convert the sensing result signal that is in accordance with the Bluetooth standard into a signal that is in accordance with the WiFi standard, and transmit the converted signal to the IoT server.

The processor may be configured to, in response to completion of transmission of the received sensing result to the IoT server, inactivate the second communicator.

The sensing result may include at least one from among a result of sensing whether a door is open or closed, a result of sensing a human body, and a result of motion recognition.

The electronic apparatus may further include a display, wherein the processor is configured to control the display to display a user interface (UI), for displaying the received sensing result and for notifying when transmission of the received sensing result to the IoT server is completed.

The electronic apparatus may further include a storage, wherein the processor is configured to, in response to receiving the sensing result signal from the remote control device, store the sensing result included in the sensing result signal, in the storage, and activate the second communicator a predetermined period of time after the sensing result is stored to transmit the sensing result to the IoT server.

The processor may be configured to group the received sensing result based on at least one from among a timing of sensing the received sensing result, a sensed object, and a sensing method, and store the grouped sensing result in the storage.

The electronic apparatus may further include a power source configured to supply power to at least one from among the first communicator and the second communicator in response to a power on state of the electronic apparatus, and supply power to only the first communicator among the first communicator and the second communicator in response to the standby state of the electronic apparatus.

According to an aspect of another exemplary embodiment, there is provided a method of controlling an electronic apparatus, the electronic apparatus including a first communicator and a second communicator, the method including: receiving a sensing result signal, including a sensing result sensed by at least one sensing device, from a remote control device configured to remotely control the electronic apparatus, through the first communicator, the first communicator having an activated state in a standby state of the electronic apparatus; in response to receiving the sensing result signal, activating the second communicator configured to perform communication with an Internet of things (IoT) server, the second communicator having an inactivated state in the standby state of the electronic apparatus; and transmitting the sensing result received from the remote control device to the IoT server through the activated second communicator.

The method may further include transmitting state information of the electronic apparatus to the remote control device, wherein the receiving includes receiving the sensing result signal further including an activation signal from the remote control device based on the state information of the electronic apparatus, and wherein the activating includes activating the second communicator in response to the sensing result signal further including the activation signal.

The method may further include, in response to receiving the sensing result signal, converting the sensing result into a signal that is in accordance with a communication standard of the second communicator, wherein the transmitting includes transmitting the converted signal to the IoT server.

The first communicator may be configured to perform communication with the remote control device using a Bluetooth standard, and the second communicator may be configured to perform the communication with the IoT server using a WiFi standard. The converting may include converting, in response to receiving the sensing result signal, the sensing result signal in accordance with the Bluetooth standard into a signal that is in accordance with the WiFi standard. The transmitting the converted signal may include transmitting the converted signal in accordance with the WiFi standard to the IoT server.

The method may further include, in response to completion of transmission of the received sensing result to the IoT server, inactivating the second communicator.

The sensing result may include at least one from among a result of sensing whether a door is open or closed, a result of sensing a human body, and a result of motion recognition.

The method may further include displaying a UI for displaying the received sensing result and for notifying when transmission of the received sensing result to the IoT server is completed.

The method may further include, in response to receiving the sensing result signal from the remote control device, storing the received sensing result included in the sensing result signal, wherein the activating includes activating the second communicator a predetermined period of time after the received sensing result is stored, and wherein the transmitting includes transmitting the sensing result to the IoT server.

The storing may include grouping the received sensing result based on at least one from among a timing of sensing the received sensing result, a sensed object, and a sensing method, and storing the grouped sensing result.

According to an aspect of still another exemplary embodiment, provided is a system including: a remote control device configured to remotely control an electronic apparatus, receive a sensing result sensed by at least one sensing device, and transmit a sensing result signal including the sensing result to the electronic apparatus; and the electronic apparatus including: a first communicator configured to perform communication with the remote control device, the first communicator having an activated state in a standby state of the electronic apparatus; and a second communicator configured to perform communication with an Internet of things (IoT) server, the second communicator having an inactivated state in the standby state of the electronic apparatus, wherein the electronic apparatus is configured to, in response to receiving the sensing result signal from the remote control device, activate the second communicator to transmit the sensing result received from the remote control device to the IoT server.

According to an aspect of still another exemplary embodiment, provided is a non-transitory computer readable storage medium having stored thereon a program which, when executed by a computer, causes the computer to perform the above-described method.

According to an aspect of still another exemplary embodiment, provided is an electronic apparatus including: a communicator configured to communicate with an Internet of things (IoT) server; and a processor configured to detect whether IoT data is received and selectively activate the communicator in response to detecting that the IoT data is received to transmit the IoT data to the IoT server through the communicator.

The processor may be configured to selectively activate the communicator in response to a standby mode of the electronic apparatus.

### BRIEF DESCRIPTION OF THE DRAWINGS

The above and/or other aspects will become more apparent by describing certain exemplary embodiments with reference to the accompanying drawings, in which:

FIG. 1 is a view illustrating an internet of things (IoT) environment using a hub;

FIG. 2 is a view illustrating an IoT system according to an exemplary embodiment;

FIGS. 3A and 3B are block diagrams illustrating a configuration of an electronic device according to exemplary embodiments;

FIG. 4 is a sequence view for explaining a process of receiving a sensing result in an electronic device according to an exemplary embodiment;

FIG. 5 is a flowchart for explaining a process of transmitting a sensing result to an IoT server from an electronic device according to an exemplary embodiment;

FIGS. 6A and 6B are views for explaining operations of an electronic device according to exemplary embodiments;

FIG. 7 is a view for explaining a method of storing a sensing result to be transmitted to an IoT server according to an exemplary embodiment; and

FIG. 8 is a flowchart for explaining a control method of an electronic device according to an exemplary embodiment.

### DETAILED DESCRIPTION

Certain exemplary embodiments are described in greater detail below with reference to the accompanying drawings.

In the following description, like drawing reference numerals are used for the like elements, even in different drawings. The matters defined in the description, such as detailed construction and elements, are provided to assist in a comprehensive understanding of exemplary embodiments. However, exemplary embodiments can be practiced without those specifically defined matters. Also, well-known functions or constructions are not described in detail since they would obscure exemplary embodiments with unnecessary detail.

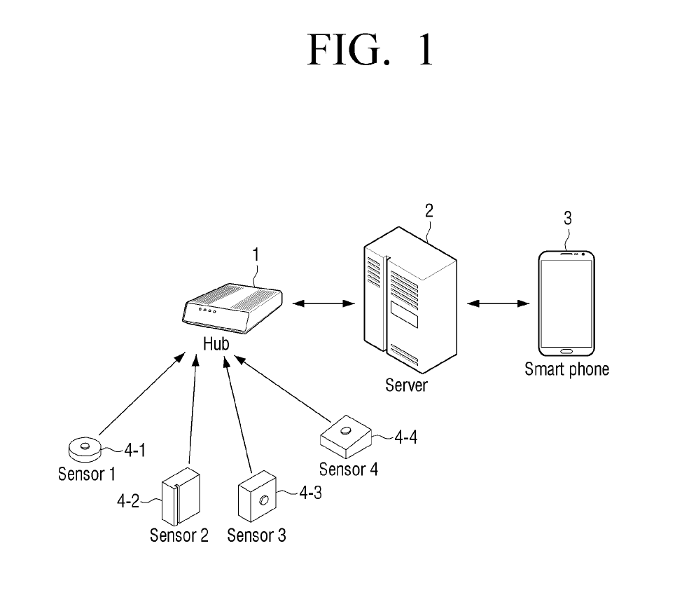

FIG. 1 is a view illustrating an Internet of things (IoT) environment using a hub.

Referring to FIG. 1, a hub 1 receives a sensing result from a plurality of sensing devices 4-1, 4-2, 4-3, and 4-4, and transmits the received sensing result to a server 2. The server 2 is connected to user terminal devices such as, for example, a smart phone 3, a desktop personal computer (PC) and the like to provide the sensing result to the user.

The hub 2 that collects the sensing result includes a sensor communicator (not shown) and a server communicator (not shown) of which power needs to be always turned on, thereby consuming a significant amount of waiting power. Furthermore, in order to provide the hub 2, the cost for providing the IoT environment increases.

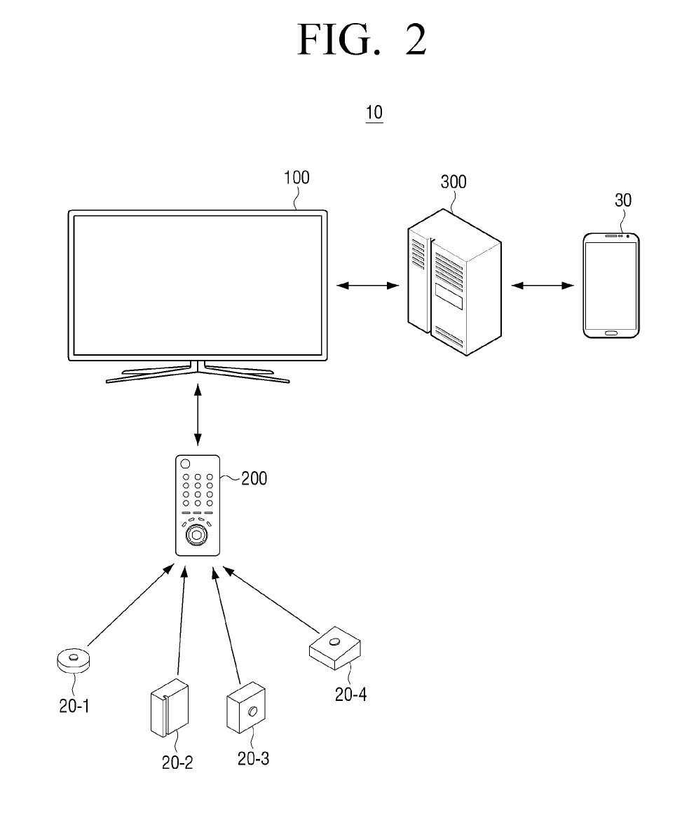

FIG. 2 is a view illustrating an Internet of things (IoT) system 10 according to an exemplary embodiment. As illustrated in FIG. 2, the IoT system 10 includes an electronic device 100, a remote control device 200, an IoT server 300, a plurality of sensing devices 20-1, 20-2, 20-3, and 20-4, and a smart phone 30.

The electronic device 100 may perform communication with the remote control device 200. Particularly, the electronic device 100 may receive from the remote control device 200 a signal that includes a sensing result that is sensed by the plurality of sensing devices 20-1 to 20-4. A communicator (not shown) included in the electronic device 100 that performs communication with the remote control device 200 may be constantly in an activated state. The sensing result may include a sensing result that is sensed by one of the plurality of sensing devices 20-1 to 20-4, or a sensing result that is sensed by some or all of the plurality of sensing devices 20-1 to 20-4. For example, the plurality of sensing devices 20-1 to 20-4 may be connected with each other in an interlocked manner. The electronic device 100 may also receive a control signal for controlling the electronic device 100 from the remote control device 200.

The sensing result (or Internet of Things (IoT) data) may include, for example but not limited to, a result of at least one of sensing whether a door is open or closed, sensing a human body, and motion recognition. Also, the plurality of sensing devices 20-1 to 20-4 may include various types of sensing devices such as, for example, a camera, a motion sensor, a temperature sensor, a humidity sensor, a light sensor, etc. However, this is merely an example and the exemplary embodiments are not limited thereto.

The electronic device 100 may transmit a piece of information (or state information) on a state of the electronic device 100 to the remote control device 200. The state information of the electronic device 100 may be information on whether the electronic device 100 is in a power on state or a standby state. In response to a power on state of the electronic device 100, power may be supplied to all of components included in the electronic device 100. On the other hand, in response to a standby state of the electronic device 100, power may be supplied to only one or some of the components included in the electronic device 100.

In response to receiving the signal that includes a sensing result, the electronic device 100 may activate a certain communicator that is in an inactivated state. The certain communicator may be different from the communicator that performs communication with the remote control device 200. When the electronic device 100 is in a standby state, the certain communicator may be in an inactivated state, while the communicator that performs communication with the remote control device 200 is in an activated state. That is, the certain communicator may be selectively activated in response to receiving the signal that includes a sensing result.

For example, the signal that includes a sensing result may include, but is not limited thereto, a signal including only the sensing result. Also, for example, the signal that includes a sensing result may further include a signal for controlling the electronic device 100 and/or a signal for activating the certain communicator of the electronic device 100.

The electronic device 100 may transmit the received sensing result to the IoT server 300 using the activated certain communicator. The electronic device 100 may transmit only the received sensing result to the IoT server 300. For example, the electronic device 100 may receive a signal that includes the sensing result as well as a signal for controlling the electronic device 100 from the remote control device 200. In this case, the electronic device 100 may transmit only the sensing result to the IoT server 300 among the received sensing result and the received signal for controlling the electronic device 100. When transmitting the received sensing result to the IoT server 300, the electronic device 100 may change a communication standard and transmit the received sensing result according to the changed communication standard. For example, the electronic device 100 may receive a signal that includes a sensing result according to a Bluetooth standard, and change the received signal to a signal according to a WiFi standard, and transmit the changed signal to the IoT server 300.

The remote control device 200 may receive the sensing result from at least one of the sensing devices 20-1 to 20-4. The remote control device 200 may transmit the received sensing result to the electronic device 100. The remote control device 200 may be controlled to be constantly in an activated state to receive the sensing result from the at least one of the sensing devices 20-1 to 20-4. The remote control device 200 may use at least one of, for example, a Z-Wave communication standard and a Zigbee communication standard to receive the sensing result from the at least one of the sensing devices 20-1 to 20-4. The received signal is transmitted within the remote control device 200 via a universal asynchronous receiver/transmitter (UART) communication to a micro controller unit (MCU) of the remote control device 200. The MCU of the remote control device 200 changes the received signal to a signal that is in accordance with the communication standard that is used for communication between the electronic device 100 and the remote control device 200, and transmits the signal to the electronic device 100.

The remote control device 200 may incorporate at least one of a signal for controlling the electronic device 100 and a signal for activating the certain communicator into the received sensing result, and transmit the received sensing result to the electronic device 100. For example, the remote control device 200 may receive the state information of the electronic device 100 from the electronic device 100. In response to determining that the state of the electronic device 100 is a standby state according to the received state information of the electronic device 100, the remote control device 200 may transmit the signal that includes the signal for activating the certain communicator of the electronic device 100 and the received sensing result to the electronic device 100. As described above, in response to a standby state of the electronic device 100, a certain component of the electronic device 100 may be in an inactivated state where power is not provided thereto.

In response to the remote control device 200 not receiving the state information of the electronic device 100, the remote control device 200 may transmit a signal that includes at least one of a sensing result and a control signal for controlling the electronic device 100 to the electronic device 100.

In response to the remote control device 200 receiving the state information of the electronic device 100, the remote control device 200 may transmit the sensing result and an activation signal for activating the certain component of the electronic device 100 to the electronic device 100. In a power on state or a standby state, the electronic device 100 may transmit the state information of the electronic device 100 to the remote control device 200. On the other hand, in a power off state, the electronic device 100 is not capable of transmitting the state information of the electronic device 100 to the remote control device 200. The power off state may include a state where a power cable of the electronic device 100 is not connected to power and thus power is not being supplied to the electronic device 100. In response to not receiving the state information from the electronic device 100 for a predetermined period of time, it may be determined that the electronic device 100 is in a power off state, and the user may be notified that the electronic device 100 is in a power off state by, for example, flickering of a light emitting diode (LED) provided in the remote control device 200.

The plurality of sensing devices 20-1 to 20-4 may transmit to the remote control device 200 respective sensing results thereof upon sensing the sensing result. In an exemplary embodiment, the plurality of sensing devices 20-1 to 20-4 may be constantly in an activated state to perform a sensing operation in real time.

The IoT server 300 may receive the sensing result from the electronic device 100 and provide the sensing result to the user. However, in response to determining that the electronic device 100 is in a power off state, the IoT server 300 may notify the user that the electronic device 100 is in a power off state.

The smart phone 30 may receive the sensing result from the IoT server 300. However, this is only an example, and the exemplary embodiments are not limited thereto. For example, the smart phone 30 may be configured to access the IoT server 300 and check the sensing result in response to a user command. FIG. 2 illustrates a case of a user terminal being the smart phone 30. However, the exemplary embodiments are not limited thereto and any electronic device capable of accessing the IoT server 300 may be used. For example, the user may check the sensing result by using a desk top PC, a tablet PC, and the like.

Also, FIG. 2 illustrates that the electronic device 100 is a display device, but the exemplary embodiments are not limited thereto. For example, the electronic device 100 may be a desk top PC or a tablet PC provided with a display, or a set top box where a display is not provided.

Hereinafter, an exemplary embodiment in which the electronic device 100 operates in a standby state will be described. However, when needed, explanation will be made with respect to the electronic device 100 being in a power on or power off state.

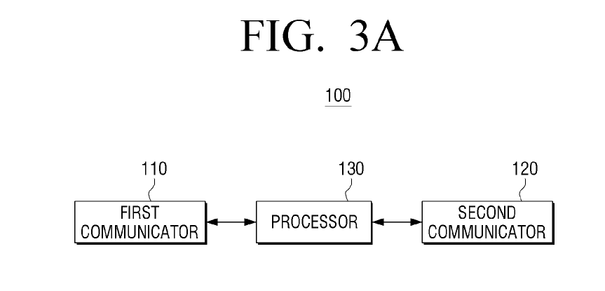

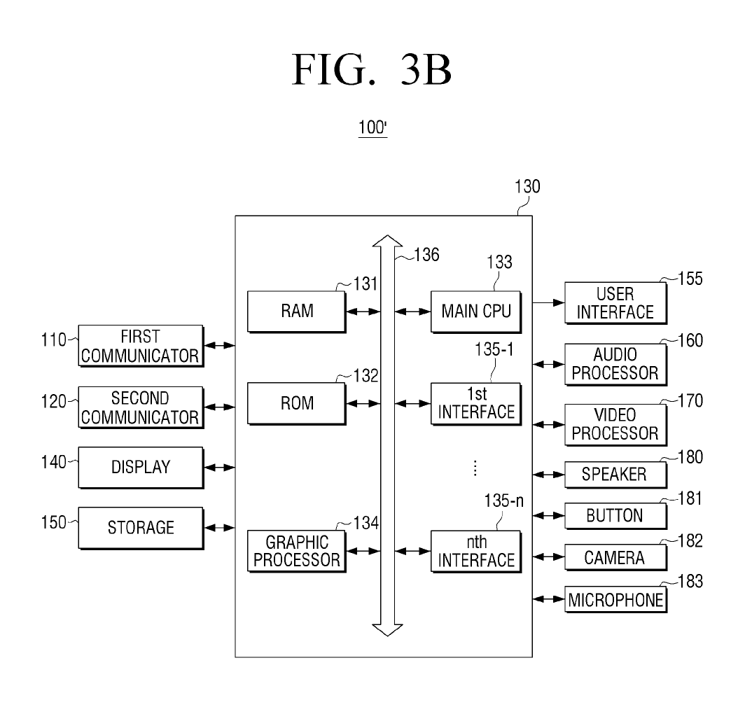

FIGS. 3A and 3B are block diagrams illustrating a configuration of the electronic device 100 according to an exemplary embodiment.

According to FIG. 3A, the electronic device 100 includes a first communicator 110, a second communicator 120, and a processor 130.

FIG. 3A illustrates components of the electronic device 100 in a case where the electronic device 100 is provided with communication functions. Therefore, depending on embodiments, some of the components illustrated in FIG. 3A may be omitted or changed, or other types of components may be further included.

The first communicator 110 performs communication with the remote control device 200.

Specifically, the first communicator 110 communicates with the remote control device 200 that remotely controls the electronic device 100, and the first communicator 110 is in an activated state in response to a standby state of the electronic device 100. The first communicator 110 may receive from the remote control device 200 a signal that includes a sensing result sensed by at least one sensing device.

The first communicator 110 may perform unilateral communication and/or bilateral communication with the remote control device 200. In the case of performing unilateral communication, the first communicator 110 may receive a signal from the remote control device 200. In the case of performing bilateral communication, the first communicator 110 may receive a signal from the remote control device 200 and/or transmit a signal to the remote control device 200.

The second communicator 120 performs communication with the IoT server 300.

Specifically, the second communicator 120 may transmit a sensing result received through the first communicator 110 to the IoT server 300. Herein, in a case where the electronic device 100 is in a standby mode, the second communicator 120 may be converted from an inactivated state into an activated state, and transmit the sensing result to the IoT server 300.

The second communicator 120 may perform unilateral communication and/or bilateral communication with the IoT server 300. In the case of performing unilateral communication, the second communicator 120 may transmit a signal to the IoT server 300. In the case of performing bilateral communication, the second communicator 120 may receive a signal from the IoT server 300 and/or transmit a signal to the IoT server 300.

In response to receiving a signal that includes a sensing result sensed by at least one sensing device, the processor 130 may activate the second communicator 120, and transmit the sensing result received from the remote control device 200 to the IoT server 300.

The processor 130 may transmit state information of the electronic device 100 to the remote control device 200, receive from the remote control device 200 a signal including the sensing result and/or an activation signal in response to the state information of the electronic device 100, and in response to the received signal including the activation signal, activate the second communicator 120.

In response to receiving the signal that includes the sensing result, the processor 130 may convert the sensing result into a signal that is in accordance with the communications standard of the second communicator 120, and transmit the converted signal to the IoT server 300.

In an exemplary embodiment, the first communicator 110 may perform communication with the remote control device 200 using the Bluetooth standard, while the second communicator 120 performs communication with the IoT server 300 using the WiFi standard, and in response to receiving the signal that includes the sensing result, the processor 130 may convert the sensing result from the signal that is in accordance with the Bluetooth standard into a signal that is in accordance with the WiFi standard, and transmit the converted signal to the IoT server 300.

In response to completion of transmission of the sensing result received from the remote control device 200 to the IoT server 300, the processor 130 may inactivate the second communicator 120.

The sensing result may include, for example but not limited to, a result of at least one of sensing whether a door is open or closed, sensing a human body, and motion recognition.

The electronic device 100 may further include a display (not shown), and the processor 130 may control the display to display a user interface (UI) for displaying the received sensing result and for notifying when transmission of the received sensing result to the IoT server 300 is completed.

The electronic device 100 may further include a storage (not shown), and in response to receiving the signal that includes the sensing result sensed by the at least one sensing device, the processor 130 may store the received sensing result in the storage, and activate the second communicator 120 in a predetermined time interval to transmit the sensing result stored in the storage to the IoT server 300.

The processor 130 may group the sensing result based on at least one of a timing of sensing the sensing result, a sensed object, and a sensing method, and store the grouped sensing result in the storage.

The electronic device 100 may further include a power source configured to supply power to the first communicator 110 and the second communicator 120 in response to a power on state of the electronic device 100, and to supply power to the first communicator 110 but not to the second communicator 120 in response to a standby state of the electronic device 100.

FIG. 3B is a block diagram illustrating a configuration of an electronic device 100′ according to another exemplary embodiment. According to FIG. 3B, the electronic device 100′ includes a first communicator 110, a second communicator 120, a processor 130, a display 140, a storage 150, a user interface 155, an audio processor 160, a video processor 170, a speaker 180, a button 181, a camera 182, and a microphone 183. Explanation on components of FIG. 3B that are the same or substantially similar to those illustrated in FIG. 3A will be omitted.

The processor 130 controls overall operations of the electronic device 100 using various instructions and/or programs stored in the storage 150.

Specifically, the processor 130 includes a random access memory (RAM) 131, a read only memory (ROM) 132, a main central processing unit (CPU) 133, a graphic processor 134, a 1st to nth interfaces 135-1 to 135-n, and a bus 136.

The RAM 131, the ROM 132, the main CPU 133, the graphic processor 134, and the 1st to nth interfaces 135-1 to 135-n may be connected to one another through the bus 136.

The 1st to nth interfaces 135-1 to 135-n are connected to various components among the above-described components. One of the 1st to nth interfaces 135-1 to 135-n may be a network interface that is connected to an external device through the network.

The main CPU 133 accesses the storage 150, and performs booting using an operating system (O/S) stored in the storage 150. The main CPU 133 performs various operations using various instructions and/or programs stored in the storage 150.

In the ROM 132, a command for booting the system is stored. When power is supplied in response to a turn on command, the main CPU 133 copies the O/S stored in the storage 150 to the RAM 131 according to the command for booting the system stored in the ROM 132, and boots the system by executing the O/S. In response to the booting being completed, the main CPU 133 copies various application programs stored in the storage 150 to the RAM 131, and performs various operations by executing the application programs copied to the RAM 131.

The graphic processor 134 generates a screen that includes various objects such as an icon, an image, a text, and the like using an arithmetic operator (not shown) and a renderer (not shown). The arithmetic operator arithmetically operates attribute values such as a coordinate value, a shape, a size, a color and the like of each object to be displayed according to a layout of the screen. The renderer generates screens having various layouts, based on the attribute values of objects arithmetically operated by the arithmetic operator. The screen generated by the renderer is displayed on a display area of the display 140.

The above-described operations of the processor 130 may be performed by the programs stored in the storage 150.

The storage 150 stores various data such as an O/S software module for driving the electronic device 100, information on the sensing result, and various information on a graphic user interface (GUI) and the like.

The processor 130 may receive, transmit, and display the sensing result based on the information stored in the storage 150.

The user interface 155 receives various user interactions. Herein, the user interface 155 may be provided in one of various formats depending on embodiments of the electronic device 100. In a case where the electronic device 100 is provided in a digital television (TV), the user interface 155 may include, for example, a remote receiver that receives a remote control signal from the remote control device 200, a camera that senses a user motion, and a microphone that receives a user voice. In a case where the electronic device 100 is provided in a touch-based portable terminal, the user interface 155 may include a touch screen that forms a mutual layer structure with a touch pad. In this case, the display 140 may be used for the user interface 155.

The audio processor 160 is a component that processes audio data. Various processes such as decoding, amplifying, and noise filtering of the audio data may be performed by the audio processor 160.

The video processor 170 is a component that processes video data. Various image processes such as decoding, scaling, noise filtering, frame rate conversion, and resolution conversion of the video data may be performed by the video processor 170.

The speaker 180 is a component that outputs various audio data processed in the audio processor 160, various alarm sounds, and/or voice messages and the like.

The button 181 may be provided in various types such as a mechanical button, a touch pad, and a wheel, and the button 181 may be formed on an area of a front surface, a side surface, and/or a rear surface of an exterior of a main body of the electronic device 100′.

The camera 182 is a component for capturing a still image and/or a video according to the user's control. The camera 182 may include a plurality of cameras including a front camera and a rear camera, for example. The microphone 183 is a component for receiving user's voice or other sounds and converting the user's voice or sounds into audio data.

In response to a power on state of the electronic device 100, the power source (not shown) may supply power to the first communicator 110 and the second communicator 120, and in response to a standby state of the electronic device 100, the power source may supply power to the first communicator 110 but not to the second communicator 120.

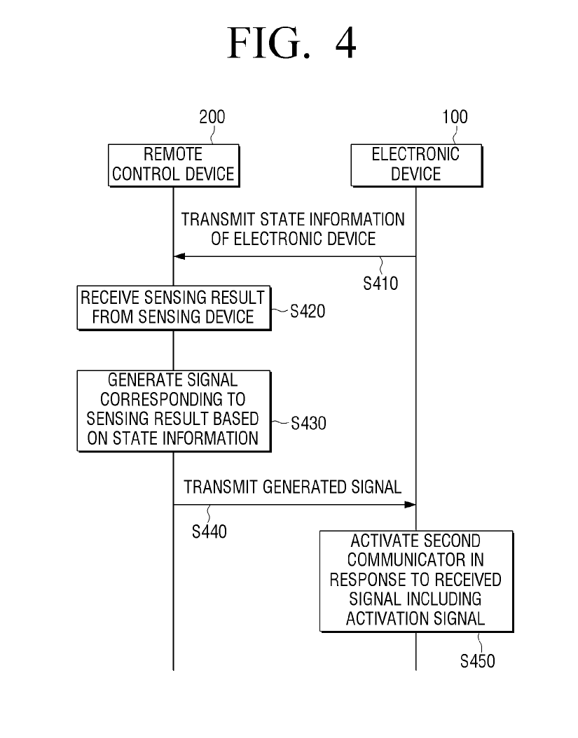

FIG. 4 is a sequence view for explaining a process of the electronic device 100 receiving a sensing result according to an exemplary embodiment.

According to FIG. 4, the processor 130 transmits state information of the electronic device 100 to the remote control device 200 (S410). Accordingly, the remote control device 200 may determine whether the electronic device 100 is in a power on state or a standby state. When the state information is not received from the electronic device 100 for a predetermined period of time, the remote control device 200 may determine that the electronic device 200 is in a power off state.

The remote control device 200 may receive a sensing result from the sensing device (S420), and generate a signal corresponding to the sensing result based on state information of the electronic device 100 (S430). For example, in response to determining that the electronic device 100 is in a power on state based on the state information of the electronic device 100, the remote control device 200 may generate a signal including only the sensing result and transmit the generated signal to the electronic device 100. In response to determining that the electronic device 100 is in a standby state based on the state information of the electronic device 100, the remote control device 200 may generate a signal, which includes the sensing result and a signal for activating the electronic device 100, and transmit the generated signal to the electronic device 100. In response to determining that the electronic device is in a power off state, instead of transmitting the sensing result, the remote control device 200 may flicker an LED provided in the remote control device 200 to notify the user of the power off state of the electronic device 100.

The processor 130 may receive the signal generated from the remote control device 200 (S440). The processor 130 may activate the second communicator 120 in response to the received signal including the activation signal (S450). However, the exemplary embodiments are not limited thereto, and the processor 130 may also activate the second communicator 120 in response to receiving a signal that includes the sensing result from the remote control device 200.

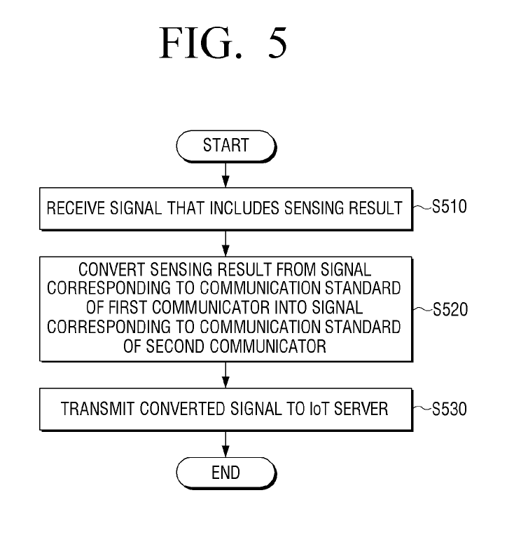

FIG. 5 is a flowchart for explaining a process of transmitting a sensing result from the electronic device 100 to the IoT server 300.

According to FIG. 5, the processor 130 receives the signal that includes the sensing result from the remote control device 200 through the first communicator 110 (S510). As described above, when the electronic device 100 is in a standby state, the first communicator 110 may be in an activated state and the second communicator 120 is in an inactivated state. In response to receiving a signal that includes the sensing result and/or in response to the received signal including the activation signal for activating the second communicator 120, the processor 130 may activate the second communicator 120.

The processor 130 may convert the sensing result into a signal that it is in accordance with the communication standard of the second communicator 120 (S520). As described above, the first communicator 110 and second communicator 120 may use different communication standards, and thus, the communication standard of the sensing result may need to be converted. The processor 130 may transmit the converted signal to the IoT server 300 (S530).

For example, assuming that the first communicator 110 communicates with the remote control device 200 using the Bluetooth standard and the second communicator 120 communicates with the IoT server 300 using the WiFi standard, the processor 130 may, in response to receiving a signal that includes the sensing result in accordance with the Bluetooth standard, convert the signal into a signal that is in accordance with the WiFi standard, and transmit the converted signal to the IoT server 300.

Although it is described in the above described exemplary embodiment that the first communicator 110 communicates with the remote control device 200 using the Bluetooth standard and the second communicator 120 communicates with the IoT server 300 using the WiFi standard, the exemplary embodiments are not limited thereto. For example, the first communicator 110 and the second communicator 120 may use communication standards from among, but not limited to, a Bluetooth low energy (BLE) communication standard, a near field communication standard, a wireless local area network (WLAN) communication standard, a ZigBee communication standard, an infrared Data Association (IrDA) communication standard, a WiFi Direct (WFD) communication standard, an ultra wideband (UWB) communication standard, and an Ant+ communication standard.

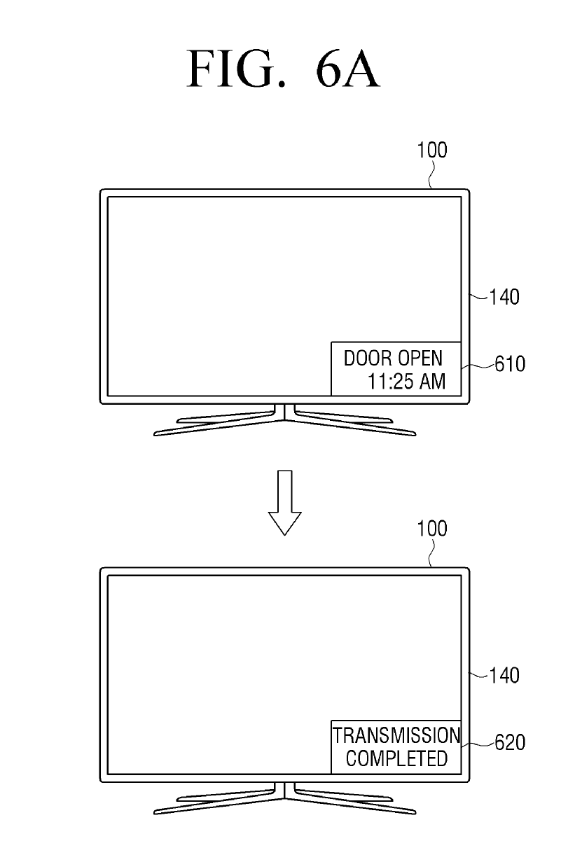

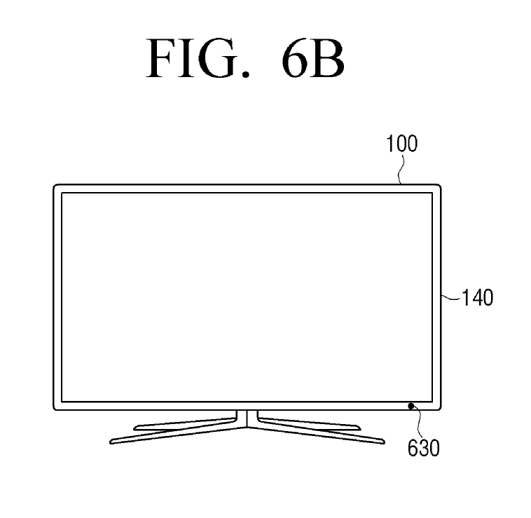

FIGS. 6A and 6B are views for explaining operations of the electronic device 100 according to exemplary embodiments.

FIG. 6A is a view for explaining an example of displaying the sensing result according to an exemplary embodiment.

According to FIG. 6A, the electronic device 100 may further include the display 140, and the processor 130 may control the display 140 to display the received sensing result 610. For example, in response to the received sensing result “door open” 610 and the time 11:25 A.M. at which the sensing result is sensed, the processor 130 may display the received information on a bottom right portion of the display 140. The processor 130 may display the information at substantially the same time the information is received.

The processor 130 may control the display 140 to display a UI 620 for notifying when the transmission of the received sensing result to the IoT server 300 is completed. For example, the processor 130 may display a message “transmission completed” on an area of the display 140 where the received sensing result 610 was previously displayed. The message may disappear after being displayed for a certain period of time on the display 140.

In FIG. 6A, the processor 130 displays the message on the bottom right portion of the screen 140, but the exemplary embodiments are not limited thereto. For example, the processor 130 may display the message on a top right portion of the display 140. Also, it is possible for the user to control a setting of the electronic device 100 such that the message is not displayed.

FIG. 6B is a view for explaining the case where the electronic device 100 does not display any content on the display 140. However, the exemplary embodiments are not limited thereto, and the exemplary embodiments may be applied when the electronic device 100 displays a certain content. For example, when the electronic device 100 currently displays a certain broadcast content on the display 140, the sensing result may be displayed on the display 140 such that the display of the sensing result overlaps the display of the certain broadcast content. However, in this case, the sensing result may be displayed in an area having a smaller size on the display 140 in order to minimize interruption to the user's viewing of the broadcast content.

The electronic device 100 may display the sensing result in various methods. For example, the electronic device 100 may not display a content on an area where the sensing result is to be displayed so that readability of the sensing result by the user may be improved.

FIG. 6B is a view for explaining a method of indicating a sensing result according to another exemplary embodiment.

According to FIG. 6B, the processor 130 may indicate the sensing result using an LED 630 provided in the electronic device 100. For example, the processor 130 may control the LED 630 to flicker in response to receiving the sensing result from the remote control device 200. When transmitting the sensing result to the IoT server 300, the processor 130 may change a speed of flickering of the LED 630. However, the exemplary embodiments are not limited thereto, and in a case where the color of the LED 630 provided in the electronic device 100 is changeable, the processor 130 may change the color of the LED 630. In a case where the electronic device 100 has a plurality of LEDs 630, the processor 130 may control respective operations of the plurality of LEDs 630 to display operation states related to the sensing result to the user.

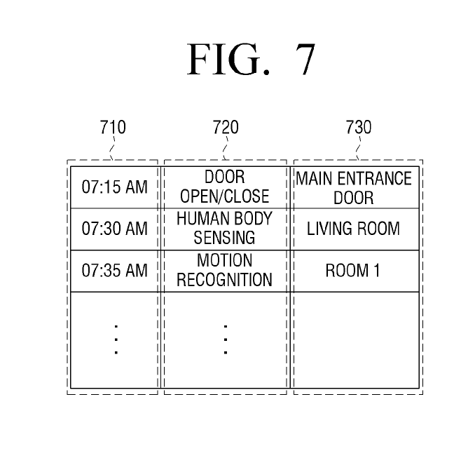

FIG. 7 is a view for explaining a method of storing the sensing result to be transmitted to the IoT server 300 according to an exemplary embodiment.

According to FIG. 7, the electronic device 100 may further include the storage 150, and the processor 130 may, in response to receiving a signal that includes the sensing result sensed by at least one sensing device, store the received sensing result in the storage 150. For example, according to FIG. 7, the processor 130 may, for example, store a timing 710 of sensing, a sensed object 720, and a place 730 of sensing and the like, but the exemplary embodiments are not limited thereto. For example, the processor 130 may store only some of the timing of sensing, the sensed object, and the place of sensing.

The processor 130 may activate the second communicator 120 a predetermined period of time after storing the sensing result to transmit the sensing result to the IoT server 300. For example, after one hour from receiving a signal that includes the sensing result to be stored in the storage 150, the processor 130 may activate the second communicator 120, and the processor 130 may transmit the sensing result that is stored in the storage 150 to the IoT server 300. In this manner, it is possible to reduce power consumption in the second communicator 120.

The processor 130 may group the sensing result based on at least one of the timing of sensing the received sensing result, the sensed object, and the sensing method, and store the grouped sensing result in the storage 150. For example, in a case of grouping the sensing result based on the sensed object, the processor 130 may store a grouped sensing result regarding whether the door is open or closed in a sequential time order, and store a grouped sensing result regarding human body sensing in a sequential time order.

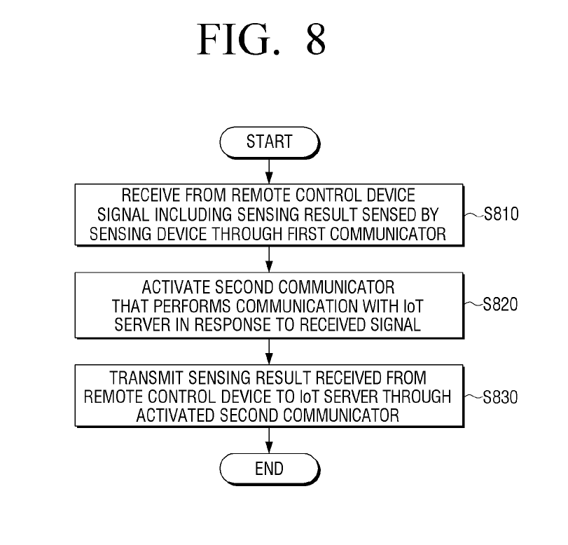

FIG. 8 is a flowchart for explaining a control method of the electronic device 100 according to an exemplary embodiment.

According to FIG. 8, a signal that includes a sensing result sensed by at least one sensing device is received from the remote control device 200, which remotely controls the electronic device 100, through the first communicator 110 (S810). In response to the received signal, the second communicator 120 that performs communication with the IoT server 300 is activated (S820). The sensing result received from the remote control device 200 is transmitted to the IoT server 300 through the activated second communicator 120 (S830).

In operation S810, state information of the electronic device 100 may be transmitted to the remote control device 200, and a signal corresponding to the sensing result may be generated based on the state information of the electronic device 100 and transmitted from the remote control device 200. For example, when the state information of the electronic device 100 indicates a standby state of the electronic device 100, the signal corresponding to the sensing result is generate such that the generated signal includes a signal (or activation signal) for activating the second communicator 120. The second communicator 120 may be activated in response to the received signal including the activation signal (S820).

In operation S820, the sensing result may need to be converted into a signal that is in accordance with the communication standard of the second communicator 120, and the converted signal is transmitted to the IoT server 300 (S830).

For example, the first communicator 110 may perform communication with the remote control device 200 using the Bluetooth standard, and the second communicator 120 may perform communication with the IoT server 300 using the WiFi standard. In this case, in operation S820, the sensing result may be converted from a signal that is in accordance with the Bluetooth standard into a signal that is in accordance with the WiFi standard in response to receiving the signal that includes the sensing result, and in operation S830, the converted signal may be transmitted to the IoT server 300.

The control method of the electronic device 100 may further include inactivating the second communicator 120 that is activated by the activation signal, in response to completion of the transmission of the sensing result received from the remote control device 200 to the IoT server 300.

The sensing result may include a result of at least one of sensing whether the door is open or closed, sensing a human body, and motion recognition. However, this is merely an example and the exemplary embodiments are not limited thereto.

The control method of the electronic device 100 may further include displaying a UI for displaying the received sensing result and for notifying when the transmission of the received sensing result to the IoT server 300 is completed.

The control method of the electronic device 100 may further include, in response to receiving a signal that includes a sensing result sensed by at least one sensing device, storing the received sensing result. In this case, in the operation S820, the second communicator 120 may be activated after a predetermined period of time after storing the received sensing result, and in operation S830, the sensing result that is stored for the predetermined period of time is transmitted to the IoT server 300.

The control method of the electronic device 100 may further include grouping the sensing result based on at least one of, for example, the timing of sensing the received sensing result, the sensed object, and the sensing method, and store the grouped sensing result.

In the exemplary embodiments described above, the electronic device 100 transmits the sensing result to the IoT server 300, but the exemplary embodiments are not limited thereto. For example, the electronic device 100, while transmitting the sensed result to the IoT server 300, may incorporate a control signal for controlling the electronic device 100 into the sensed result such that the sensed result may be transmitted to the user.

The second communicator 120 of the electronic device 100 may be activated by the user as well as by the remote control device 200. For example, the user may activate the second communicator 120 of the electronic device 100 by inputting an activation signal by using the smart phone 30. In this case, for example, instead of activating the entirety of the second communicator 120, a minimum configuration for receiving the activation signal from the user may be activated.

According to the exemplary embodiments, the electronic device 100 receives a sensing result of a sensing device to activate a certain communicator of the electronic device 100, and transmits the received sensing result to the IoT server 300 to provide an IoT environment to the user, while minimizing consumption of waiting power.

The exemplary embodiments may be programmed in computer instructions and/or codes and stored in various storage media. Accordingly, the methods according to the exemplary embodiments may be implemented in various types of electronic devices (e.g., general-use computers) that execute the computer instructions and/or codes stored in a computer readable storage medium.

Specifically, according to an exemplary embodiment, there may be provided a non-transitory computer readable medium that stores a program that, when executed by a computer, performs receiving a signal that includes a sensing result sensed by at least one sensing device from the remote control device, which remotely controls the electronic device, through the first communicator; activating the second communicator that performs communication with the Internet of things (IoT) server in response to receiving the signal; and transmitting the sensing result received from the remote control device to the IoT server through the activated second communicator.

The non-transitory computer readable medium refers to a computer readable medium configured to store data semi-permanently and not for a short period of time such as a register, cache, and memory and the like. Specifically, various applications and/or programs for performing the methods according to the exemplary embodiments may be stored and provided in a non-transitory computer readable medium such as a compact disk (CD), a digital versatile disk (DVD), a hard disk, a blue-ray disk, a universal serial bus (USB), a memory card, a ROM and the like.

Although a few embodiments have been shown and described, it would be appreciated by those skilled in the art that changes may be made in this embodiment without departing from the principles and spirit of the disclosure, the scope of which is defined in the claims and their equivalents.

What is claimed is:

1. An electronic apparatus comprising:
a first communicator configured to perform communication with a remote control device, which is configured to remotely control the electronic apparatus, the first communicator having an activated state in a standby state of the electronic apparatus;
a second communicator configured to perform communication with an Internet of things (IoT) server, the second communicator having an inactivated state in the standby state of the electronic apparatus; and
a processor configured to, in response to receiving a sensing result signal, comprising a sensing result sensed by at least one sensing device, from the remote control device, activate the second communicator to transmit the sensing result received from the remote control device to the IoT server.

2. The electronic apparatus according to claim 1, wherein the processor is configured to transmit state information of the electronic apparatus to the remote control device, receive the sensing result signal further comprising an activation signal from the remote control device based on the state information of the electronic apparatus, and in response to the sensing result signal further comprising the activation signal, activate the second communicator.

3. The electronic apparatus according to claim 1, wherein the processor is configured to, in response to receiving the sensing result signal, convert the sensing result signal into a signal that is in accordance with a communication standard of the second communicator, and transmit the converted signal to the IoT server.

4. The electronic apparatus according to claim 3, wherein the first communicator is configured to perform the communication with the remote control device using a Bluetooth standard,
wherein the second communicator is configured to perform the communication with the IoT server using a WiFi standard, and
wherein the processor is configured to, in response to receiving the sensing result signal, convert the sensing result signal that is in accordance with the Bluetooth standard into a signal that is in accordance with the WiFi standard, and transmit the converted signal to the IoT server.

5. The electronic apparatus according to claim 1, wherein the processor is configured to, in response to completion of transmission of the received sensing result to the IoT server, inactivate the second communicator.

6. The electronic apparatus according to claim 1, wherein the sensing result comprises at least one from among a result of sensing whether a door is open or closed, a result of sensing a human body, and a result of motion recognition.

7. The electronic apparatus according to claim 1, further comprising:
a display,
wherein the processor is configured to control the display to display a user interface (UI), for displaying the received sensing result and for notifying when transmission of the received sensing result to the IoT server is completed.

8. The electronic apparatus according to claim 1, further comprising:
a storage,
wherein the processor is configured to, in response to receiving the sensing result signal from the remote control device, store the sensing result included in the sensing result signal, in the storage, and activate the second communicator a predetermined period of time after the sensing result is stored to transmit the sensing result to the IoT server.

9. The electronic apparatus according to claim 8, wherein the processor is configured to group the received sensing result based on at least one from among a timing of sensing the received sensing result, a sensed object, and a sensing method, and store the grouped sensing result in the storage.

10. The electronic apparatus according to claim 1, further comprising:
a power source configured to supply power to at least one from among the first communicator and the second communicator in response to a power on state of the electronic apparatus, and supply power to only the first communicator among the first communicator and the second communicator in response to the standby state of the electronic apparatus.

11. A method of controlling an electronic apparatus, the electronic apparatus comprising a first communicator and a second communicator, the method comprising:
receiving a sensing result signal, comprising a sensing result sensed by at least one sensing device, from a remote control device configured to remotely control the electronic apparatus, through the first communicator, the first communicator having an activated state in a standby state of the electronic apparatus;
in response to receiving the sensing result signal, activating the second communicator configured to perform communication with an Internet of things (IoT) server, the second communicator having an inactivated state in the standby state of the electronic apparatus; and
transmitting the sensing result received from the remote control device to the IoT server through the activated second communicator.

12. The method according to claim 11, further comprising:
transmitting state information of the electronic apparatus to the remote control device,
wherein the receiving comprises receiving the sensing result signal further comprising an activation signal from the remote control device based on the state information of the electronic apparatus, and
wherein the activating comprises activating the second communicator in response to the sensing result signal further comprising the activation signal.

13. The method according to claim 11, further comprising:
in response to receiving the sensing result signal, converting the sensing result into a signal that is in accordance with a communication standard of the second communicator,
wherein the transmitting comprises transmitting the converted signal to the IoT server.

14. The method according to claim 13, wherein the first communicator is configured to perform communication with the remote control device using a Bluetooth standard,
wherein the second communicator is configured to perform the communication with the IoT server using a WiFi standard,
wherein the converting comprises converting, in response to receiving the sensing result signal, the sensing result signal in accordance with the Bluetooth standard into a signal that is in accordance with the WiFi standard, and
wherein the transmitting the converted signal comprises transmitting the converted signal in accordance with the WiFi standard to the IoT server.

15. The method according to claim 11, further comprising:
in response to completion of transmission of the received sensing result to the IoT server, inactivating the second communicator.

16. The method according to claim 11, wherein the sensing result comprises at least one from among a result of sensing whether a door is open or closed, a result of sensing a human body, and a result of motion recognition.

17. A system comprising:
a remote control device configured to remotely control an electronic apparatus, receive a sensing result sensed by at least one sensing device, and transmit a sensing result signal comprising the sensing result to the electronic apparatus; and
the electronic apparatus comprising:
a first communicator configured to perform communication with the remote control device, the first communicator having an activated state in a standby state of the electronic apparatus; and
a second communicator configured to perform communication with an Internet of things (IoT) server, the second communicator having an inactivated state in the standby state of the electronic apparatus,
wherein the electronic apparatus is configured to, in response to receiving the sensing result signal from the remote control device, activate the second communicator to transmit the sensing result received from the remote control device to the IoT server.

18. A non-transitory computer readable storage medium having stored thereon a program which, when executed by a computer, causes the computer to perform a method according to claim 11.

19. An electronic apparatus comprising:
a communicator configured to communicate with an Internet of things (IoT) server; and
a processor configured to detect whether IoT data is received and selectively activate the communicator in response to detecting that the IoT data is received to transmit the IoT data to the IoT server through the communicator.

20. The electronic apparatus according to claim 19, wherein the processor is configured to selectively activate the communicator in response to a standby mode of the electronic apparatus.
